(19) United States
(12) Patent Application Publication
(10) Pub. No.: US 2022/0115023 A1
(43) Pub. Date: Apr. 14, 2022

(54) Voice Recognition Transmission System

(71) Applicant: Milia Cora, Columbia, SC (US)

(72) Inventor: Milia Cora, Columbia, SC (US)

(21) Appl. No.: 17/500,406

(22) Filed: Oct. 13, 2021

Related U.S. Application Data
(60) Provisional application No. 63/090,842, filed on Oct. 13, 2020.

(51) Int. Cl. G10L 17/22; G10L 17/06; G10L 17/26; B60R 25/25; B60R 25/00; B60R 25/10

(52) U.S. Cl. CPC G10L 17/22; G10L 17/06; B60R 25/1004; B60R 25/257; B60R 25/007; G10L 17/26

(57) ABSTRACT

A voice recognition transmission system for preventing unauthorized activation of a vehicle is provided. The system includes a microphone, a voice recognition module, and an automotive gear shifter. The microphone receives a voice command. The voice recognition module analyzes the voice command against a plurality of authorized voice profiles. The voice recognition module determines if the voice command reaches a threshold of similarity in tone and tenor of one authorized voice profile. A voice command that reaches the threshold of similarity will activate the automotive gear shifter to perform the voice command. A voice command that fails to reach the threshold of similarity will activate an interlock. The interlock will prevent an unauthorized individual from operating the vehicle and activate the vehicle alarm system. A notification will be sent to a connected electronic device when a voice command activates the automotive gear shifter or the interlock.

### CROSS REFERENCE TO RELATED APPLICATIONS

This application claims the benefit of U.S. Provisional Application No. 63/090,842 filed on Oct. 13, 2020. The above identified patent application is herein incorporated by reference in its entirety to provide continuity of disclosure.

### BACKGROUND OF THE INVENTION

The present invention relates to a voice recognition transmission system. More specifically, the present invention provides a voice recognition transmission system that includes an interlock configured to prevent any unauthorised users with an unapproved voice profile from activating an automotive gear shifter.

When operating an automobile, the user must manually turn the automobile engine on and off and manually shift the gear into a desired operation. Having to manually shift the automobile into a different gear requires the user to momentarily divert their focus away from what is in front of the automobile. Moreover, a user can lose focus on the road when they manually operate other features of the automobile, including windows and entertainment systems on the dashboard. With the multiple distractions that can divert the operator's attention away from the road in front of them, an automobile operator that fails to maintain the proper focus and attention on the road increases the chances that an accident may occur. Limiting the manual tasks an automobile operator must perform while the automobile is moving will lower the chances that the automobile operator becomes distracted, resulting in an accident.

Automobiles typically require the use of a key or an electronic fob to operate the automobile. For individuals who want to commit automotive theft, there are techniques available to them to bypass the need for the key or the electronic fob. These automobile thieves have the requisite skill to turn on the automobile and to operate the automobile in hopes of transporting it away from the owner. Moreover, the individuals who may not have the requisite skill to turn the automobile on sans the key or electronic fob may instead have wrongful possession of the automobile's key or electronic fob. While having possession of the automobile's key or electronic fob, the wrongful possessor does not have any impediments to entering the automobile and operating the automobile to their liking. Specifically, the automobile lacks an ability to differentiate between an authorized operator and an unauthorized operator. The automobile lacking the distinguishing capabilities deprives the owner and any authorized operator from an additional layer of security against an unauthorized operator attempting to take possession of the automobile.

Personal identifiable metrics are difficult to mimic. Technology has developed to incorporate users' distinct features to limit the access to unauthorized users. Most technological devices have been able to permit users to provide their fingerprint, their face, and their voice to gain access. These features being incorporated into the technology provide a heightened level of security. The features are designed to inhibit an unauthorized individual attempting to bypass the security measure to gain access. Any unauthorized user would require an advanced skill set to circumvent the level of security. Permitting these features to provide security to a wide array of technologies will allow the owners to have the peace of mind that their items will have a low probability of being accessed by individuals that are unauthorized.

Therefore, there is a defined need amongst the known prior art references for a voice recognition transmission system that prevents unauthorized users with an unapproved voice profile from activating the automotive gear shifter via an interlocking system.

### SUMMARY OF THE INVENTION

In view of the foregoing disadvantages inherent in the known types of voice recognition transmission systems now present in the known art, the present invention provides a new voice recognition transmission system wherein a voice recognition system and an interlock are configured prevent unauthorized users with unapproved voice profiles from activating an automotive gear shifter.

The present system comprises a voice recognition system. The voice recognition system includes a processor, a non-transitory computer readable medium, and a logic stored in the non-transitory computer readable medium. With the non-transitory computer readable medium operatively connected to the processor, the present system can perform a method for receiving a voice command and transmitting the voice command to an automotive gear shifter. The voice recognition system comprises a voice recognition module that contains a plurality of authorized voice profiles. The voice recognition module will evaluate the voice command and compare it to the plurality of authorized voice profiles. The voice recognition module decides if the voice command is of a significant similarity to one of the authorized voice profiles of the plurality of authorized voice profiles, if the voice command is of a significant similarity to one of the authorized voice profiles of the plurality of authorized voice profiles, the voice recognition system will perform an action associated with the voice command. If the voice command is not of a significant similarity to one of the authorized voice profiles of the plurality of authorized voice profiles, the voice recognition system will not perform the action associated with the voice command and instead perform a necessary preventative action. The necessary preventative action may include an activation of the vehicle's alarm system and the transmission of a notification to a connected electronic device.

The present, system comprises an interlock. The interlock is operably connected to the voice recognition module, an automotive gear shifter, and an electronic device. Upon the detection of an unauthorized user providing a voice command to the voice recognition system, the interlock will prevent the unauthorized user from activating the automotive gear shifter. The interlock will also initiate the automobile's alarm system. Activating the automobile's alarm system will dissuade an unauthorized user from further attempting to activate the automobile and alert surrounding bystanders of unwarranted access to the automobile. Additionally, the interlock will send a notification to a connected electronic device. The notification will alert the owner of the automobile that an unauthorized user attempted to activate the voice recognition system.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a flow chart of an embodiment of the voice recognition transmission system.

### DETAILED DESCRIPTION OF THE INVENTION

Reference is made herein to the attached drawings. Like reference numerals are used throughout the drawings to depict like or similar elements of the voice recognition transmission system. The figures are intended for representative purposes only and should not be limiting in any respect.

According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a non-transitory computer readable medium, e.g. a memory, wherein implementation of the logic by the processor on the electronic device provides the electronic device with the function of a special-purpose computing device.

In the interests of economy, the present disclosure refers to “a non-transitory computer readable medium,” “a processor,” and so on. However, this should not be read as limiting in anyway as the present disclosure contemplates embodiments of the present invention utilizing “one or more non-transitory computer readable medium,” “one or more processors,” and so on. Unless specifically limited to a single unit, “a” is intended to be equivalent to “one or more” throughout the present disclosure.

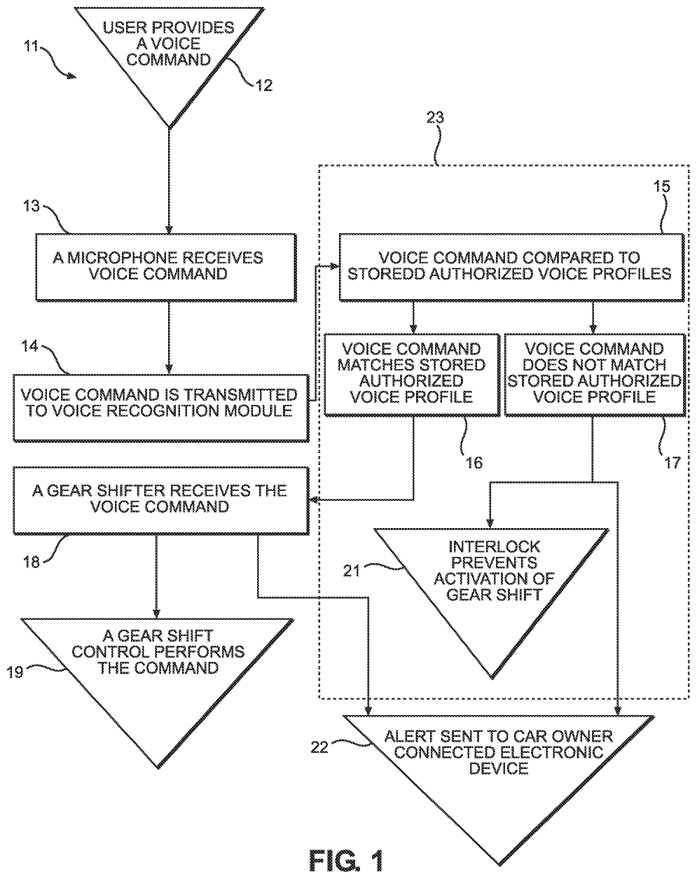

FIG. 1 shows a flow chart of an embodiment of a voice recognition transmission system. The voice recognition transmission system 11 comprises a microphone, a voice recognition module 23, and an automotive gear shifter. Owners of a vehicle may input an authorized voice profile for themselves and any authorized user of the vehicle. The voice recognition module 23 will store the authorized user's voice profile. The authorized voice profiles may further be associated with a name of the authorized user. The voice recognition module 23 can establish a tone and tenor of each authorized voice profile. Moreover, the voice recognition module 23 will establish a threshold of similarity for each authorized voice profile.

When operating the voice recognition transmission system 11, a user will provide a voice command 12. The voice command that is provided by the user will be an instruction to the voice recognition transmission system 11 to perform a specific automotive function with the vehicle. For example, the user can instruct the voice recognition transmission system 11 to start the vehicle's engine, to place the vehicle in drive, to place the vehicle in park, to place the vehicle in reverse, to place the vehicle in neutral, and to turn the vehicle's engine off. in some embodiments, other voice commands that the user may provide the vehicle is to adjust the vehicle's windows or to adjust the vehicle's entertainment dashboard.

The voice command provided by the user 12 will be received by a microphone 13. The microphone is disposed in the cabin of the vehicle. The microphone can pick up the user's voice command. The microphone allows the voice command to enter the voice recognition transmission system 11. When the voice command enters the voice recognition transmission system 11, the voice command is transmitted to the voice recognition module 14.

The voice recognition module 23 stores a plurality of authorized voice profiles. The voice recognition moduie 23 measures the tone and tenor of the plurality of authorized voice profiles. When the voice command is transmitted to the voice recognition module 14, the voice recognition module 23 measures the tone and tenor of the voice command. The voice recognition module compares the tone and tenor of the voice command to the tone and tenor of the plurality of authorized voice profiles 15. A threshold of similarity is stored within the voice recognition module 23 for each authorized voice profile of the plurality of authorized voice profiles. The voice command must reach the threshold of similarity of one authorized voice profile of the plurality of authorized voice profiles to be deemed a match. The voice recognition module 23 determines whether the voice command matches one of the authorized voice profiles in the plurality of authorized voice profiles. If the tone and tenor of the voice command matches the tone and tenor of one of the authorized voice profiles of the plurality of authorized voice profiles 16, the voice command will be transmitted to a gear shifter 18. If the tone and tenor of the voice command does not match the tone and tenor of one of the authorized voice profiles of the plurality of authorized voice profiles 17, the voice recognition module 23 will activate an interlock.

When the tone and tenor of the voice command does not match the tone and tenor of one of the authorized voice profiles of the plurality of authorized voice profiles 17, the interlock will prevent the voice command from activating the gear shifter 21. When the interlock is activated, the voice command will not proceed through the remainder of the voice recognition transmission system 11. In one embodiment, the interlock will activate the vehicle alarm system. The activation of the vehicle alarm system includes emitting a sound around the vehicle. The activation of the alarm system will attempt to dissuade the unauthorized user from any further attempts to activate the voice recognition transmission system 11. When the interlock is activated, a notification will be sent to an electronic device that is connected to the voice recognition transmission system 22. Commonly, the electronic device connected to the voice recognition transmission system 11 will be the vehicle owner's electronic device. The notification will alert the owner of the electronic device that an unauthorized user has attempted to activate the voice recognition transmission system 11.

When the tone and tenor of the voice command matches the tone and tenor of one of the authorized voice profiles of the plurality of authorized voice profiles 17, the voice command is transmitted to the automotive gear shifter 18. When the automotive gear shifter receives the voice command, the automotive gear shifter performs the action of the voice command 19. If the voice command is to start the automobile's ignition, the automotive gear shifter will start the vehicle's engine, if the voice command is to turn off the vehicle's ignition, the automotive gear shifter will turn the vehicle's engine off. If the voice command is to put the vehicle in drive, the automotive gear shifter will put the vehicle in drive, if the voice command is to put a vehicle In park, the automotive gear shifter will put the vehicle in park. If the voice command is to put the vehicle in neutral, the automotive gear shifter will put the vehicle in neutral. If the voice command is to put the vehicle in reverse, the automotive gear shifter will put the vehicle in reverse. In other embodiments voice recognition transmission system 11, the voice command may alter the position of the vehicle's windows. In other embodiments voice recognition transmission system 11, the voice command may alter the functions of the vehicle's dashboard entertainment system.

When the automotive gear shifter is activated, a notification will be sent to an electronic device that is connected to the voice recognition transmission system 22. Commonly, the electronic device connected to the voice recognition transmission system 11 will be the vehicle owner's electronic device. The notification will alert the owner of the electronic device that an authorized user has successfully activated the voice recognition transmission system 11.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and ail equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A voice recognition transmission system, comprising:
microphone;
the microphone operably connected to a voice recognition module;
the voice recognition module comprising a processor, a non-transitory computer readable medium operatively connected to the processor, the non-transitory computer readable medium includes a plurality of authorized voice profiles thereon, and a logic stored in the non-transitory computer readable medium that, when executed by the processor, causes the system to perform a method, the method comprising:
receiving a voice command via the microphone;
transmitting the voice command to the non-transitory computer readable medium;
analyzing the voice command in comparison to the plurality of authorized voice profiles;
if the voice command matches an authorized voice profile of the plurality of authorized voice profiles, then the voice command is transmitted to an automotive gear shifter;
a receiver on the automotive gear shifter receives the voice command and executes an action associated with the voice command;
if the voice command fails to match an authorized voice profile of the plurality of authorized voice profiles, then an interlock prevents an unauthorized user from activating the automotive gear shifter;
transmitting a notification to a connected electronic device.

2. The voice recognition transmission system of claim 1, wherein the microphone is configured to received voice commands from an individual.

3. The voice recognition transmission system of claim 1, wherein the voice recognition module analyzes a tone and tenor of the voice command and a tone and tenor of the plurality of authorized voice profiles to determine if the tone and tenor of the voice command reaches a threshold of the tone and tenor of one of the voice profiles of the plurality of authorized voice profiles.

4. The voice recognition transmission system of claim 1, wherein the connected electronic device receives the notification and informs the owner of each attempt to operate the vehicle.

5. The voice recognition transmission system of claim 1, wherein the notification transmitted to the connected electronic device informs the owner of an attempt to activate the voice recognition module.

6. The voice recognition transmission system of claim 1, wherein the interlock prevents the vehicle from starting and operating the vehicle.

7. The voice recognition transmission system of claim 6, wherein the interlock activates a vehicle alarm and notifies the vehicle owner when an unauthorized voice command is sent to the voice recognition module.

8. The voice recognition transmission system of claim 1, wherein the voice recognition module can activate the automotive gear shifter via a plurality of voice commands.

9. A method for a voice recognition transmission, the method comprising:
receiving a voice command through a microphone;
transmitting the voice command to a voice recognition module;
analyzing the voice command in comparison to a plurality of authorized voice profiles;
activating an automotive gear shifter to perform the voice command when the voice command matches an authorized voice profile of the plurality of authorized voice profiles;
activating an interlock to prevent the voice command from activating the automotive gear shifter and activating an alarm system of the vehicle when the voice command does not match an authorized voice profile of the plurality of authorized voice profile; and
notifying an electronic device connected to the voice recognition module that an activation of the vehicle has been attempted.
